(19) United States
(12) Patent Application Publication
(10) Pub. No.: US 2021/0381279 A1
(43) Pub. Date: Dec. 9, 2021

(54) PADLOCK WITH HIDDEN SHACKLE

(71) Applicant: Wen-Yii Lin, Tainan (TW)

(72) Inventor: Wen-Yii Lin, Tainan (TW)

(73) Assignee: Wen-Yii Lin, Tainan (TW)

(21) Appl. No.: 16/946,170

(22) Filed: Jun. 9, 2020

(51) Int. Cl. E05B 67/24; E05B 67/38

(52) U.S. Cl. CPC E05B 67/24; E05B 67/38

(57) ABSTRACT

A padlock includes a case including a main part and a board which is mounted to the main part. The main part includes a room therein and a block is located in the room. A lock cylinder is located in room and includes a keyhole and shaft. A chamber is formed in block in the room. The board includes an operation space and a shackle is movably located in the operation space. A notch is defined through the board and communicates with the chamber. The shackle includes an engaging hole in which the shaft of the lock cylinder is securely engaged. The staple is inserted into the notch and an end of the shackle pivotably passes through the notch and the chamber, and the staple when operating the lock cylinder. The shackle is hidden in the case and difficult to be accessed from outside of the case.

### BACKGROUND OF THE INVENTION

### 1. Fields of the Invention

The present invention relates to a padlock, and more particularly, to a padlock with a hidden shackle which is operated within a case.

### 2. Descriptions of Related Art

The conventional padlock “A” as disclosed in FIG. 1 generally cooperated with a hasp and staple set “B”. The hasp “B1” is fixed to one fixed part and the staple “B3” is fixed to a pivotable part which can be a lid or a door. The hasp “B1” includes a slot “B0” through which the staple “B3” extends. The staple “B3” includes a hole “B2”. The padlock “A” includes a shackle “A0” which is pivotably connected to a lock case.

The shackle “A0” extends through the hole “B2” of the staple “B3” and is locked so that the door (for example) cannot be opened. The shackle “A0” is separated from the lock body by using a correct key to unlock the padlock “A”. The shackle “A0” is exposed and can be easily cut or damaged to remove the hasp “B1” from the staple “B3”.

The present invention intends to provide a padlock that has a hidden shackle operated within a case so that the shackle is protected from being cut.

### SUMMARY OF THE INVENTION

The present invention relates to a padlock and comprises a case 1 including a main part and a board which is removably mounted to a peripheral wall of the main part. The main part includes multiple connection portions which are engaged with the receiving portions of the board to connect the board to the main part. A room is defined in the case and a block located in the room. A passage and a chamber are respectively formed in the block in the room. A first path is formed in the block in the room and has an opening which communicates with the chamber. The board includes an operation space and a second path respectively formed in the inside thereof. The second path is located corresponding to the first path. A notch is defined through the board and communicates an opening of the second path. The notch is located corresponding to and communicates with the chamber. A lock cylinder is located in the passage and includes a keyhole located corresponding to the reception hole of the main part. A shaft is rotatably located on the second end of the lock cylinder. A shackle is movably located in the first and second paths. The shackle has an engaging hole in which the shaft of the lock cylinder is securely engaged. The shackle is pivotable within the operation space, the first path and the second path. An end of the shackle passes through the notch and the chamber when the shaft of the lock cylinder is rotated.

Preferably, the connection portions are pegs and the receiving portions are holes with which the pegs are engaged.

Preferably, the shaft of the lock cylinder is a non-circular shaft. The engaging hole of the shackle is shaped such that the shaft is securely engaged with the engaging hole.

The primary object of the present invention is to provide a padlock wherein the shackle is hidden in the case of the padlock so as to be protected from being cut or damaged.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional padlock and a hasp and staple set;

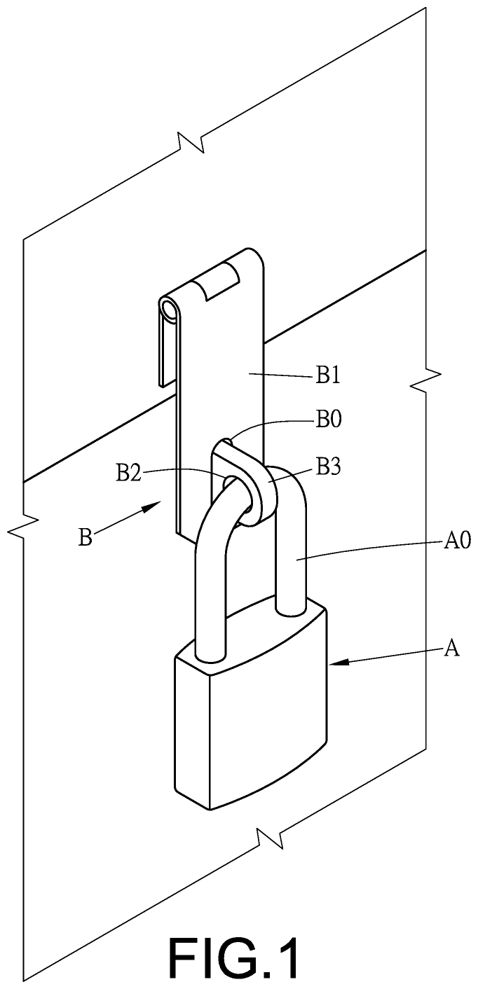

FIG. 2 is an exploded view so show the padlock of the present invention;

FIG. 3 is a perspective view to show the padlock of the present invention, wherein the padlock is in unlocked status;

FIG. 4 is a perspective view to show the padlock of the present invention, wherein the padlock is in locked status;

FIG. 5 shows the padlock of the present invention and a hasp and staple set;

FIG. 6 shows that a key is inserted into the padlock of the present invention;

FIG. 7 is a plan view to show that the padlock of the present invention is locked, and

FIG. 8 is a plan view to show that the padlock of the present invention is unlocked.

### DETAILED DESCRIPTION OF THE INVENTION

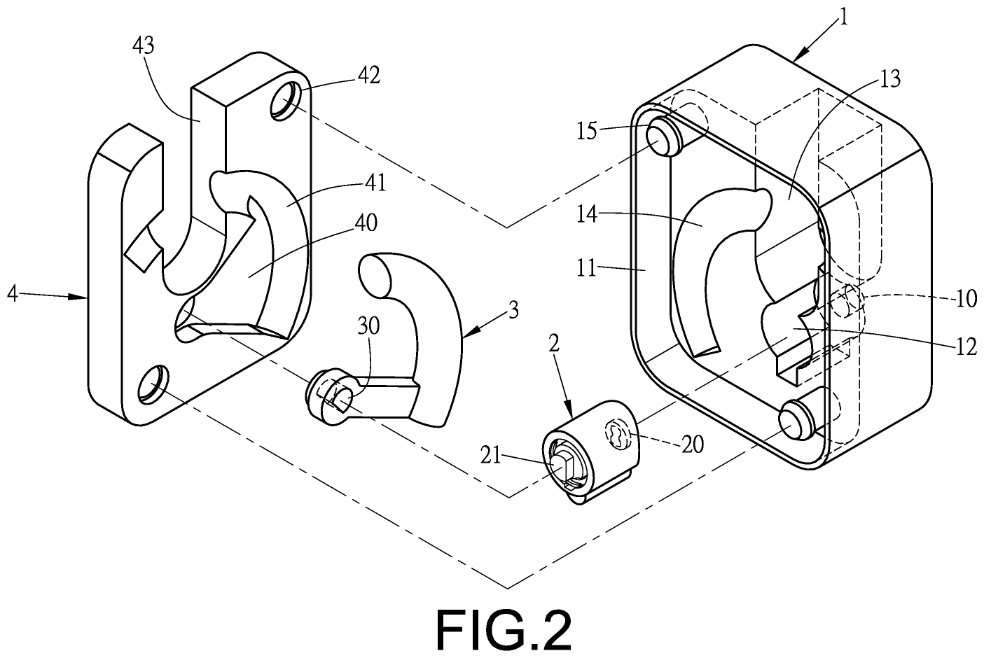

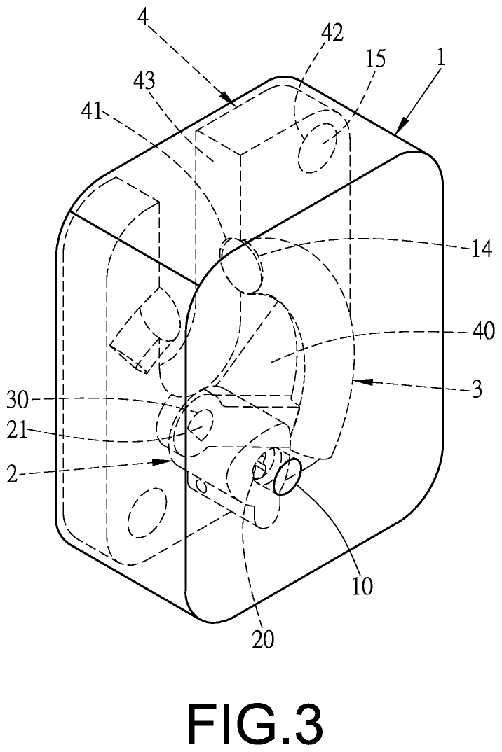

Referring to FIGS. 2 and 3, the padlock of the present invention comprises a case 1, a lock cylinder 2, and a board 4. The case 1 includes a main part and the board 4 is removably mounted to the peripheral wall of the main part. The main part includes multiple connection portions 15 at corners thereof. The connection portions 15 are pegs. A reception hole 10 is defined through the first face of the case 1. A room 11 is defined in the case 1 and a block is located in the room 11. A passage 12 and a chamber 13 are respectively formed in the block in the room 11. A first path 14 is formed in the block in the room 11 and has an opening which communicates with the chamber 13. The lock cylinder 2 is located in the passage 12 and includes a keyhole 20 defined the first end thereof. The keyhole 20 is located corresponding to the reception hole 10. A shaft 21 is rotatably located on the second end of the lock cylinder 2, and the shaft 21 of the lock cylinder 2 is a non-circular shaft.

The board 4 includes an operation space 40 and a second path 41 respectively formed in the inside thereof. The second path 41 is located corresponding to the first path 14 when the board 4 is connected to the main part. A notch 43 is defined through the board 4 and communicates an opening of the second path 41. The notch 43 is located corresponding to and communicates with the chamber 13 when the board 4 is connected to the main part. The board 4 includes multiple receiving portions 42 which are holes with which the connection portions 1 are engaged to connect the board 4 to the main part. Of course, any known method can be used to connect the board 4 to the main part.

A shackle 3 is movably located in the first and second paths 15, 41. The shackle 3 includes an engaging hole 30 formed in the first end thereof. The engaging hole 30 of the shackle 3 is shaped such that the shaft 21 is securely engaged with the engaging hole 30.

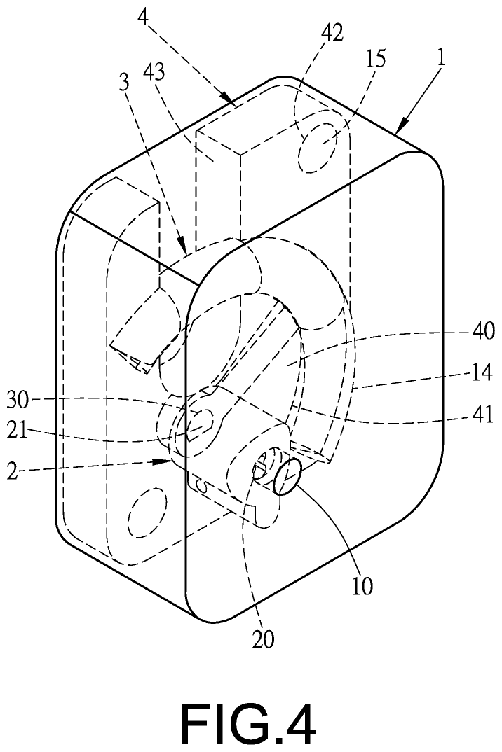

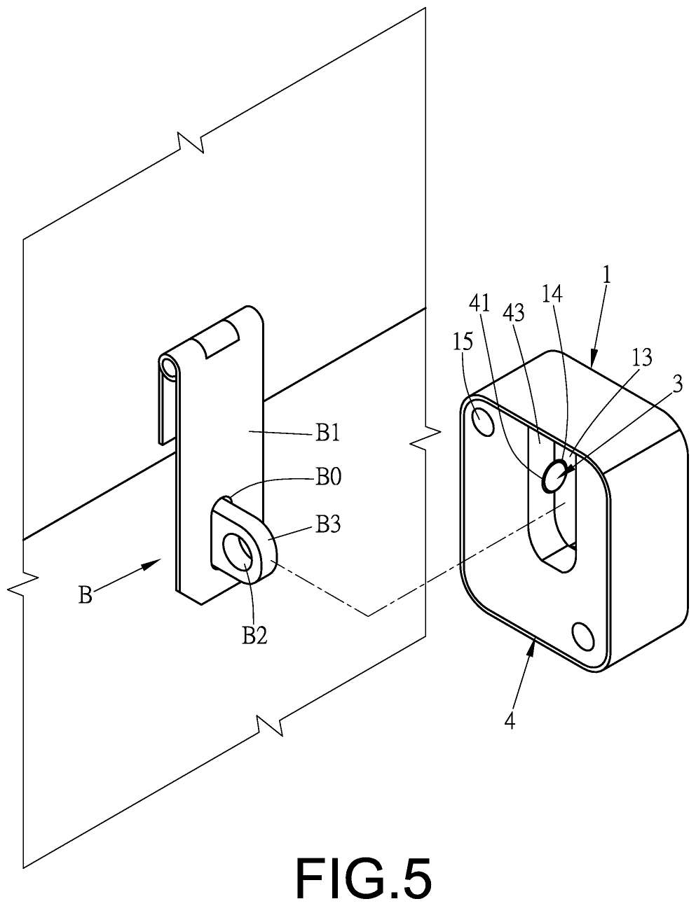

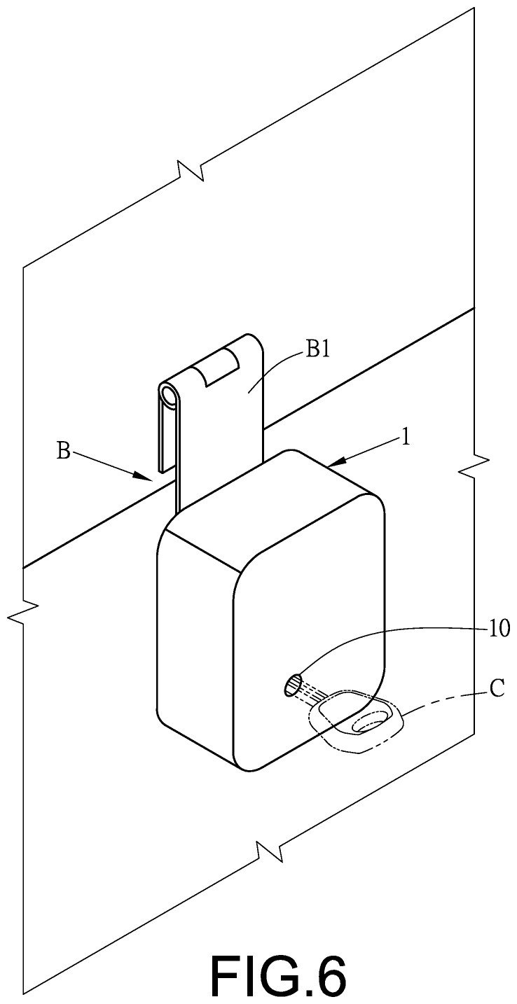

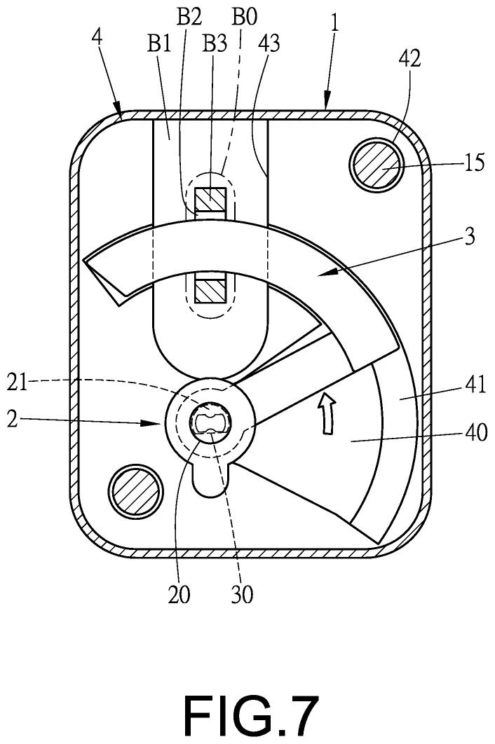

As shown in FIGS. 3, 5 and 8, the staple “B3” extends through the slot “B0” of the hasp “B1”. The staple “B3” is inserted into the notch 43 of the board 4. The user then inserts a key “C” through the reception hole 10 and inserts the key “C” into the lock cylinder 2 to rotate to lock the padlock. The lock cylinder 2 is rotated as shown in FIGS. 4, 6 and 7 to lock the padlock, and the shaft 21 of the lock cylinder 2 is rotated to rotate the shackle 3. The second end of the shackle 3 moves and passes through the hole “B2” of the staple “B3”, the chamber 13 and the notch 43. The second end of the shackle 3 enters into a recess formed in the board 4 and the block in the room 11. Therefore, the case 1 is not separated from the staple “B3”.

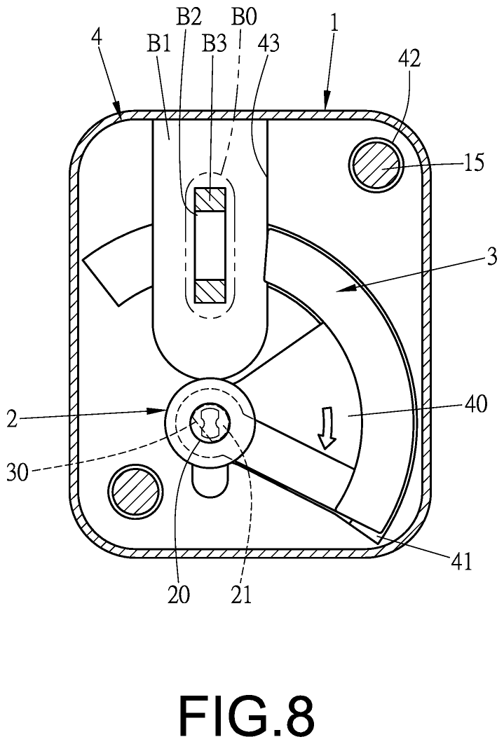

As shown in FIG. 8, when the user uses the key “C” to unlock the padlock, the lock cylinder 2 is rotated in opposite direction, and the shaft 21 of the lock cylinder 2 rotates the shackle 3 so that the second end of the shackle 3 retracts, and the shackle 3 is pivoted back to its initial position as shown in FIGS. 3 and 8. The case 1 is then able to be separated from the staple “B3”.

The padlock is looked as a rectangular case (other shapes may also be used) so that the shackle 3 is hidden in the case 1 and difficult to be accessed from outside of the case 1.

While we have shown and described the embodiment in accordance with the present invention, it should be clear to those skilled in the art that further embodiments may be made without departing from the scope of the present invention.

What is claimed is:

1. A padlock comprising:
a case including a main part and a board which is removably mounted to a peripheral wall of the main part, the main part having multiple connection portions, a reception hole defined through a first face of the case, a room defined in the case and a block located in the room, a passage and a chamber respectively formed in the block in the room, a first path formed in the block in the room and having an opening which communicates with the chamber, the board having an operation space and a second path respectively formed in an inside thereof, the second path located corresponding to the first path, a notch defined through the board and communicating an opening of the second path, the notch is located corresponding to and communicating with the chamber, the board having multiple receiving portions with which the connection portions are engaged to connect the board to the main part;
a lock cylinder located in the passage and including a keyhole defined a first end thereof, the keyhole located corresponding to the reception hole, a shaft rotatably located on a second end of the lock cylinder, and
a shackle movably located in the first and second paths, the shackle having an engaging hole in which the shaft of the lock cylinder is securely engaged, the shackle being pivotable within the operation space, the first path and the second path, an end of the shackle passing through the notch and the chamber when the shaft of the lock cylinder is rotated.

2. The padlock as claimed in claim 1, wherein the connection portions are pegs and the receiving portions are holes with which the pegs are engaged.

3. The padlock as claimed in claim 1, wherein the shaft of the lock cylinder is a non-circular shaft, the engaging hole of the shackle is shaped such that the shaft is securely engaged with the engaging hole.
